(19) United States
(12) Patent Application Publication
(10) Pub. No.: US 2013/0264884 A1
(43) Pub. Date: Oct. 10, 2013

(54) ALTERNATING CURRENT PHOTOVOLTAIC MODULE AND METHOD FOR MANAGING ELECTRICITY THEREIN

(71) Applicant: AU OPTRONICS CORPORATION, Hsin-Chu (TW)

(72) Inventors: Min-Chien KUO, HSIN-CHU (TW); Yung-Cheng HUANG, HSIN-CHU (TW)

(73) Assignee: AU OPTRONICS CORPORATION, HSIN-CHU (TW)

(21) Appl. No.: 13/710,550

(22) Filed: Dec. 11, 2012

(30) Foreign Application Priority Data
Apr. 9, 2012 (CN) 201210099843.2

(51) Int. Cl. H02J 1/00

(52) U.S. Cl. CPC H02J 1/00
USPC 307/80

(57) ABSTRACT

An alternating current photovoltaic module includes a photovoltaic cell module, an inverter, and an electricity storing component. The inverter includes an electricity transforming unit and a micro control unit. The photovoltaic cell module operates to transform luminous energy into electricity. The electricity transforming unit operates to transform electricity. In addition, the micro control unit operates to control the inverter to deliver the electricity which is generated by photovoltaic cell module and transformed by the electricity transforming unit to the electricity storing component for storing the electricity. The micro control unit also operates to control the electricity storing component for providing the stored electricity in the electricity storing component.

### RELATED APPLICATIONS

This application claims priority to China Application Serial Number 201210099843.2, filed Apr. 9, 2012, which is herein incorporated by reference.

### BACKGROUND

1. Technical Field

The embodiment of the present invention relates generally to generation, conversion, or managing of electricity and, more particularly, to an alternating current photovoltaic module for managing electricity converted from solar power energy, and to a method for managing electricity in the alternating current photovoltaic module.

2. Description of Related Art

At present, fossil fuel is the main energy source used to produce electricity. However, the amount of fossil fuel is limited, and so the demand for alternative energy has increased in recent years.

Because solar energy is clean, pollution-free, and limitless, it is the most suitable alternative energy for solving the problems associated with the use of fossil fuel, namely, pollution and limited supply. The solar photovoltaic industry, which began with the invention of the photovoltaic cell by Bell laboratories in 1954, has become an important aspect for developing the next generation energy resource.

In a solar power generation system, a conventional structure includes an inverter and a plurality of photovoltaic cell panels, and the inverter is connected to the photovoltaic cell panels in series. The output efficiency of the conventional structure is decreased due to improper sunshine distribution on the photovoltaic cell panel and uneven performance of the photovoltaic cell panel, resulting in a significant reduction in the overall output efficiency of the system. Therefore, each of the photovoltaic cell panels is equipped with an inverter with the aim of remedying this problem.

When there is sufficient sunshine, the photovoltaic cell panel will generate a great deal of electricity. Therefore, an important area that is in need of improvement is that related to how the electricity generated by a photovoltaic cell panel can be efficiently managing when there is sufficient sunshine. Furthermore, when there is little or no sunshine (such as on a cloudy day or at night), a photovoltaic cell panel cannot provide electricity continuously or may not be able to provide electricity at all, and so there is a need for a solution when there is little or no sunshine. Moreover, another area in need of improvement is that related to the problem of mismatch between a photovoltaic cell panel and an inverter will lead to the inefficient use of the electricity generated by the photovoltaic cell panel.

### SUMMARY

An alternating current photovoltaic module and a method for managing electricity therein are provided. The alternating current photovoltaic module and method manage electricity efficiently.

One aspect of the embodiment of the present invention is to provide an alternating current photovoltaic module. The alternating current photovoltaic module comprises a photovoltaic cell module, an inverter, and an electricity storing component. Furthermore, the inverter comprises an electricity transforming unit and a control unit. The electricity transforming unit is electrically connected to the photovoltaic cell module, the control unit is electrically connected to the electricity transforming unit, and the electricity storing component is electrically connected to the electricity transforming unit and the control unit.

In a first embodiment of the present invention, the photovoltaic cell module operates to transform a luminous energy into a generated electricity. The electricity transforming unit operates to transform the generated electricity generated by the photovoltaic cell module. The electricity storing component operates to store a transformed electricity transformed by the electricity transforming unit. The control unit is configured control the inverter to deliver the transformed electricity transformed by the electricity transforming unit to the electricity storing component, so as to store the transformed electricity in the electricity storing component and control the electricity storing component for providing the stored electricity stored in the electricity storing component. Hence, the generated electricity generated by the photovoltaic cell module can be managing efficiently due to the fact that generated electricity generated by the photovoltaic cell module can be stored when necessary, and accordingly, the stored electricity can be provided to electrical components as needed.

In a second embodiment of the present invention, additional technical features are added herein based on the first embodiment. When a power of the generated electricity generated by the photovoltaic cell module is greater than a rated power of the inverter, the control unit operates to control the inverter to deliver a exceeding portion of the transformed electricity transformed from the power of the generated electricity exceeding the rated power to the electricity storing component, so as to store the exceeding portion of the transformed electricity in the electricity storing component

In a third embodiment of the present invention, additional technical features are added herein based on the second embodiment. When the power of the generated electricity generated by the photovoltaic cell module is less than the rated power of the inverter, the control unit operates to control the electricity storing component to provide a stored electricity stored in the electricity storing component. Hence, the electricity which cannot be transformed efficiently due to the limitation of the rated power of the inverter can be stored for future use.

In a fourth embodiment of the present invention, additional technical features are added herein based on the third embodiment. The electricity transforming unit comprises a direct current to direct current converter and a direct current to alternating current converter. With respect to the structure, the direct current to direct current converter is electrically connected to the photovoltaic cell module, and the direct current to alternating current converter is electrically connected to the direct current to direct current converter. With respect to the operation, the direct current to direct current converter is configured to transform the generated electricity generated by the photovoltaic cell module into the transformed electricity in direct current type, and the direct current to alternating current converter is configured to transform the transformed electricity transformed by the direct current to direct current converter and/or the stored electricity stored in the electricity storing component into an output electricity in alternating current type.

In a fifth embodiment of the present invention, additional technical features are added herein based on the fourth embodiment. The electricity storing component is electrically connected between the direct current to direct current converter and the direct current to alternating current converter, when the control unit is configured to control the inverter to deliver the transformed electricity transformed by the direct current to direct current converter to the electricity storing component, so as to store the transformed electricity in the electricity storing component, all or a portion of the transformed electricity transformed by the direct current to direct current converter is provided to the electricity storing component, so as to store all or a portion of the transformed electricity in the electricity storing component, and when the control unit is operable to control the electricity storing component to provide the stored electricity stored in the electricity storing component, the stored electricity stored in the electricity storing component is transformed into an output electricity in alternating current type through the direct current to alternating current converter.

In a sixth embodiment of the present invention, additional technical features are added herein based on the first embodiment. When a power of the generated electricity generated by the photovoltaic cell module is greater than a required power of the load, the control unit operates to control the inverter to deliver a exceeding portion of the transformed electricity transformed from the power of the generated electricity exceeding the required power of the load to the electricity storing component, so as to store the exceeding portion of the transformed electricity in the electricity storing component.

In a seventh embodiment of the present invention, additional technical features are added herein based on the sixth embodiment. When the power of the generated electricity generated by the photovoltaic cell module is less than the required power of the load, the control unit operates to control the electricity storing component to provide a stored electricity stored in the electricity storing component. Hence, excess electricity can be stored when the generated electricity generated by the photovoltaic cell module is greater than the required power of the load, and the stored electricity stored in the electricity storing component can be reused as needed.

In a eighth embodiment of the present invention, additional technical features are added herein based on the seventh embodiment. The electricity transforming unit comprises a direct current to direct current converter and a direct current to alternating current converter. The direct current to direct current converter is electrically connected to the photovoltaic cell module, the direct current to alternating current converter is electrically connected to the direct current to direct current converter, and the electricity storing component is electrically connected between the direct current to direct current converter and the direct current to alternating current converter. The direct current to direct current converter is configured to transform the generated electricity generated by the photovoltaic cell module into the transformed electricity in direct current type. The direct current to alternating current converter is configured to transform the transformed electricity transformed by the direct current to direct current converter and/or the stored electricity stored in the electricity storing component into an output electricity in alternating current type.

In a ninth embodiment of the present invention, additional technical features are added herein based on the eighth embodiment. The electricity storing component is electrically connected between the direct current to direct current converter and the direct current to alternating current converter, when the control unit is operable to control the inverter to deliver the transformed electricity transformed by the electricity transforming unit; to the electricity storing component, so as to store the transformed electricity in the electricity storing component, all or a portion of the transformed electricity transformed by the direct current to direct current converter is provided to the electricity storing component, so as to store all or a portion of the transformed electricity in the electricity storing component, and when the control unit is operable to control the electricity storing component to provide the stored electricity stored in the electricity storing component, the stored electricity stored in the electricity storing component is transformed into alternating current through the direct current to alternating current converter.

In a tenth embodiment of the present invention, additional technical features are added herein based on the first embodiment. The electricity transforming unit comprises a direct current to direct current converter and a direct current to alternating current converter. With respect to the structure, the direct current to direct current converter is electrically connected to the photovoltaic cell module, and the direct current to alternating current converter is electrically connected to the direct current to direct current converter. With respect to the operation, the direct current to direct current converter is configured to transform the generated electricity generated by the photovoltaic cell module into the transformed electricity in direct current type, and the direct current to alternating current converter is configured to transform the transformed electricity transformed by the direct current to direct current converter and/or the stored electricity stored in the electricity storing component into an output electricity in alternating current type.

In an eleventh embodiment of the present invention, additional technical features are added herein based on the tenth embodiment. The electricity storing component is electrically connected between the direct current to direct current converter and the direct current to alternating current converter, when the control unit is configured to control the inverter to deliver the transformed electricity transformed by the direct current to direct current converter to the electricity storing component, so as to store the transformed electricity in the electricity storing component, all or a portion of the direct current transformed by the direct current to direct current converter is provided to the electricity storing component, so as to store all or a portion of the direct current in the electricity storing component, and when the control unit is operable to control the electricity storing component to provide the stored electricity stored in the electricity storing component, the stored electricity stored in the electricity storing component is transformed into alternating current through the direct current to alternating current converter.

In a twelfth embodiment of the present invention, additional technical features are added herein based on the tenth embodiment. The electricity storing component is electrically connected between the direct current to direct current converter and the direct current to alternating current converter.

In a thirteenth embodiment of the present invention, additional technical features are added herein based on the twelfth embodiment. The direct current to direct current converter comprises a detector. The detector is electrically connected to the photovoltaic cell module, and the detector is configured to detect the generated electricity generated by the photovoltaic cell module for obtaining the power of the generated electricity generated by the photovoltaic cell module.

In a fourteenth embodiment of the present invention, additional technical features are added herein based on the first embodiment. The alternating current photovoltaic module further comprises a junction box. The junction box is electrically connected to the electricity transforming unit and the photovoltaic cell module, and the photovoltaic cell module is electrically connected to the electricity transforming unit through the junction box.

In another aspect of the embodiment of the present invention, a method for managing electricity is provided. In a first embodiment of the present invention, the method for managing electricity comprises the following steps:

transforming a luminous energy into a generated electricity by a photovoltaic cell module;

transforming the generated electricity generated by the photovoltaic cell module by an inverter into an outputted electricity;

providing the outputted electricity transformed by the inverter to a load;

controlling the inverter to deliver an exceeding portion of the power of a transformed electricity transformed from the power of the generated electricity exceeding the rated power to the electricity storing component when the power of the generated electricity generated by the photovoltaic cell module is greater than the rated power of the inverter, so as to store the exceeding portion of the transformed electricity in the electricity storing component; and

controlling the electricity storing component to provide the stored electricity stored in the electricity storing component when the power of the generated electricity generated by the photovoltaic cell module is less than the rated power of the inverter.

In a second embodiment of the present invention, additional technical features are added herein based on the first embodiment. The step of controlling the electricity storing component to provide the stored electricity stored in the electricity storing component when the power of the generated electricity generated by the photovoltaic cell module is less than the rated power of the inverter comprises controlling the electricity storing component to provide the stored electricity stored in the electricity storing component when the power of the generated electricity generated by the photovoltaic cell module is less than the rated power of the inverter and the power of the generated electricity generated by the photovoltaic cell module is less than the required power of the load.

In a third embodiment of the present invention, additional technical features are added herein based on the second embodiment. The inverter comprises a direct current to direct current converter and a direct current to alternating current converter, and the step of transforming the generated electricity generated by the photovoltaic cell module by the inverter into the outputted electricity further comprises:
transforming the generated electricity generated by the photovoltaic cell module into the transformed electricity in direct current type by the direct current to direct current converter; and
to transforming all or a portion of the transformed electricity transformed by the direct current to direct current converter into the outputted electricity in alternating current type by the direct current to alternating current converter;
wherein:
   providing the outputted electricity transformed by the inverter to the load comprises providing the outputted electricity transformed by the direct current to alternating current converter to the load;
   controlling the inverter to deliver a exceeding portion of the transformed electricity transformed from the power of the generated electricity exceeding the rated power to the electricity storing component, so as to store the exceeding portion of the transformed electricity in storing component comprises providing all or a portion of the transformed electricity transformed by the direct current to direct current converter to the electricity storing component, so as to store all or a portion of the transformed electricity in the electricity storing component; and
   controlling the electricity storing component to provide the stored electricity stored in the electricity storing component comprises controlling the electricity storing component to provide the stored electricity stored in the electricity storing component to the direct current to alternating current converter for transforming the stored electricity stored in the electricity storing component into the output electricity.

Another method for managing electricity in a first embodiment of the present invention comprises the following steps:

transforming a luminous energy into a generated electricity by a photovoltaic cell module;

transforming the generated electricity generated by the photovoltaic cell module by an inverter into an outputted electricity;

providing the outputted electricity transformed by the inverter to a load;

controlling the inverter to deliver a exceeding portion of a transformed electricity transformed from the power of the generated electricity exceeding the required power of the load to the electricity storing component, so as to store the exceeding portion of the transformed electricity in the electricity storing component when the power of the generated electricity generated by the photovoltaic cell module is greater than the required power of the load; and

controlling the electricity storing component to provide the stored electricity stored in the electricity storing component when the power of the generated electricity generated by the photovoltaic cell module is less than the required power of the load.

In a second embodiment of the present invention, additional technical features are added herein based on the first embodiment. The step of controlling the electricity storing component to provide the stored electricity stored in the electricity storing component when the power of the generated electricity generated by the photovoltaic cell module is less than the required power of the load comprises controlling the electricity storing component to provide the stored electricity stored in the electricity storing component when the power of the generated electricity generated by the photovoltaic cell module is less than the required power of the load and the power of the generated electricity generated by the photovoltaic cell module is less than the rated power of the inverter.

In a third embodiment of the present invention, additional technical features are added herein based on the second embodiment. The inverter comprises a direct current to direct current converter and a direct current to alternating current converter, and the step of transforming the generated electricity generated by the photovoltaic cell module by the inverter into the outputted electricity further comprises:
transforming the generated electricity generated by the photovoltaic cell module into the transformed electricity in direct current type by the direct current to direct current converter; and
transforming all or a portion of the transformed electricity transformed by the direct current to direct current converter into the outputted electricity in alternating current type by the direct current to alternating current converter;
wherein:
   providing the outputted electricity transformed by the inverter to the load comprises providing the outputted electricity transformed by the direct current to alternating current converter to the load;
   controlling the inverter to deliver a exceeding portion of the transformed electricity transformed from the power of the generated electricity exceeding the rated power to the electricity storing component, so as to store the exceeding portion of the transformed electricity in storing component comprises providing all or a portion of the transformed electricity transformed by the direct current to direct current converter to the electricity storing component, so as to store all or a portion of the transformed electricity in the electricity storing component; and
   controlling the electricity storing component to provide the stored electricity stored in the electricity storing component comprises controlling the electricity storing component to provide the stored electricity stored in the electricity storing component to the direct current to alternating current converter for transforming the stored electricity stored in the electricity storing component into the output electricity.

As a result, the alternating current photovoltaic module and the method for managing electricity therein provided by the embodiments of the present invention manage all the power provided by the solar cell module efficiently, and excess electricity can be stored in the electricity storing component.

### BRIEF DESCRIPTION OF THE DRAWINGS

The invention can be more fully understood by reading the following detailed description of the embodiments, with reference made to the accompanying drawings as follows:

FIG. 1 schematically shows a circuit block diagram of an alternating current photovoltaic module according to one embodiment of the present invention.

FIG. 2 schematically shows a circuit block diagram of an alternating current photovoltaic module according to another embodiment of the present invention.

FIG. 3 schematically shows a circuit block diagram of an inverter according to an embodiment of the present invention.

FIG. 4 schematically shows a circuit block diagram of an alternating current photovoltaic module according to yet another embodiment of the present invention.

FIG. 5A schematically shows a flow diagram of a method for managing electricity in an alternating current photovoltaic module according to an embodiment of the present invention.

FIG. 5B schematically shows a flow diagram of a method for managing electricity in an alternating current photovoltaic module according to another embodiment of the present invention.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “including,” “having,” “containing,” “involving,” and the like are to be understood to be open-ended, i.e., to mean including but not limited to.

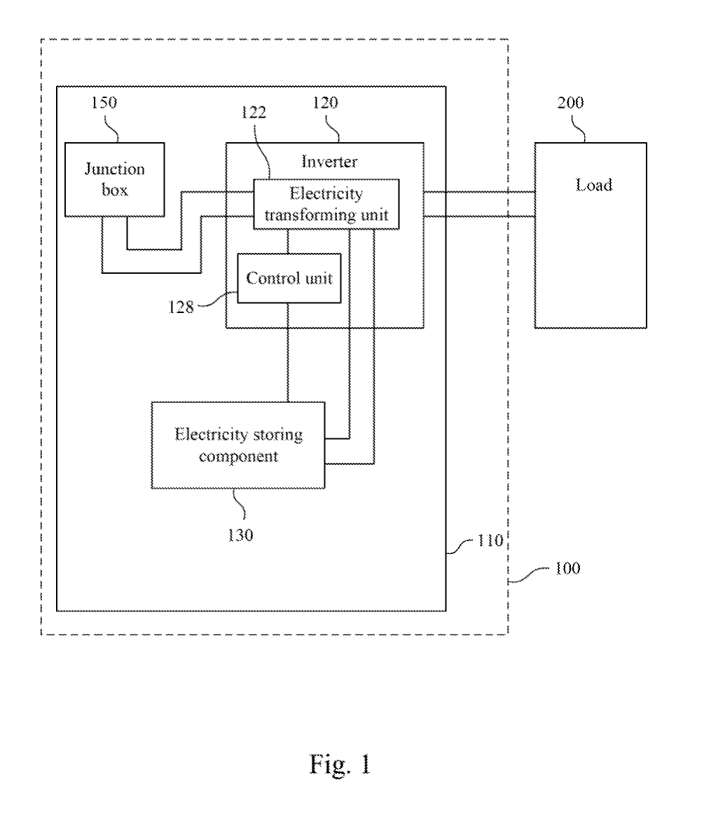

FIG. 1 schematically shows a circuit block diagram of an alternating current photovoltaic module 100 according to one embodiment of the present invention. In one aspect of the embodiment of the present disclosure, the alternating current photovoltaic module 100 comprises a photovoltaic cell module 110, an inverter 120, and an electricity storing component 130. Furthermore, the inverter 120 comprises an electricity transforming unit 122 and a control unit 128. With respect of the configuration, the electricity transforming unit 122 is electrically connected to the photovoltaic cell module 110, the control unit 128 is electrically connected to the electricity transforming unit 122, and the electricity storing component 130 is electrically connected to the electricity transforming unit 122 and the control unit 128.

When implementing the electricity storing component 130, those skilled in the art can selectively adopt components which can store enough electricity therein, for example a lead-acid battery, a nickel-cadmium battery, a nickel-metal hydride battery, a lithium-ion battery, and so on, to manufacture the electricity storing component 130. The above-mentioned components can provide stored electricity stored therein. However, the embodiment of the present disclosure is not intended to be limited in this regard, and these examples are provided for illustration purposes only to represent different possible implementations of the present disclosure.

With respect to operation, the photovoltaic cell module 110 operates to transform a luminous energy into a generated electricity, and the electricity transforming unit 122 operates to transform the generated electricity generated by the photovoltaic cell module 110.

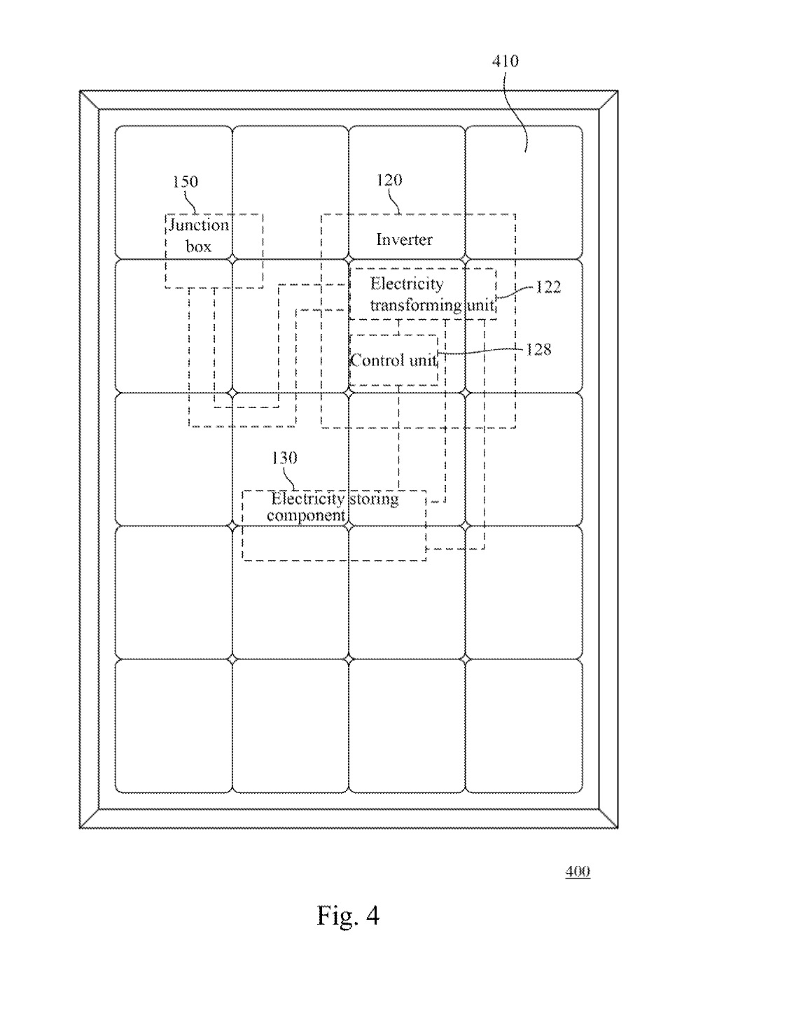

The above-mentioned photovoltaic cell module 110 comprises at least one photovoltaic cell 410 as illustrated in FIG. 4. When implementing the photovoltaic cell 410, the photovoltaic cell 410 can be implemented by conventional materials such as silicon or a chemical compound, which can be used as the main material of the photovoltaic cell 410. If silicon is used as the main material, the different types of silicon include monocrystalline silicon, polycrystalline silicon, amorphous silicon, and so on, and such different types of silicon can be used as the main material to manufacture the photovoltaic cell module 110. If, however, a chemical compound is used as the main material, the different types of the chemical compound include GaAs, CdS/CdTe, CIGS, and so on, and such different chemical compounds can be used as the main material to manufacture the photovoltaic cell module 110. Such different types of silicon and chemical compounds differ in cost, electricity conversion efficiency, difficulty of manufacture, or related applications. Those skilled in the art can selectively use proper materials to manufacture the photovoltaic cell module 110 depending on actual requirements. Moreover, when implementing the inverter 120, those skilled in the art can selectively use a square wave inverter, a step wave inverter, a sinusoidal wave inverter, and so on to manufacture the inverter 120 depending on actual requirements. However, the embodiment of the present disclosure is not intended to be limited in this regard, and these examples are provided for illustration purposes only to represent different possible implementations of the present disclosure.

In the embodiment, when a power of the generated electricity generated by the photovoltaic cell module 110 is greater than a rated power of the inverter 120, the control unit 128 operates to control the inverter 120 to deliver a exceeding portion of the transformed electricity transformed from the power of the generated electricity exceeding the rated power to the electricity storing component 130, so as to store the exceeding portion of the transformed electricity in the electricity storing component 130. Moreover, when the power of the generated electricity generated by the photovoltaic cell module 110 is less than the rated power of the inverter 120, the control unit 128 operates to control the electricity storing component 130 to provide a stored electricity stored in the electricity storing component 130.

For example, when there is sufficient sunshine, the power of the generated electricity generated by the photovoltaic cell module 110 is greater than the rated power of the inverter 120, and as a result, the excess electricity can be managing efficiently and stored in the electricity storing component 130 at this time. On the other hand, when there is insufficient or no sunshine (e.g., on a cloudy day or at night), the power of the generated electricity generated by the photovoltaic cell module 110 is less than the rated power of the inverter 120, and as a result, the control unit 128 operates to control the electricity storing component 130 to provide the stored electricity stored in the electricity storing component 130 at this time.

As mentioned above, when the photovoltaic cell module 110 and the inverter 120 of the alternating current photovoltaic module 100 are used, the power of the photovoltaic cell module 110 and that of the inverter 120 are different, resulting in a problem of mismatch between the photovoltaic cell module 110 and the inverter 120. The total power provided by the photovoltaic cell module 110 is usually greater than the rated power of the inverter 120. In such a scenario, the inverter 120 will limit the total power provided by the photovoltaic cell module 110 in such a manner that the total power provided by the photovoltaic cell module 110 is not greater than the rated power of the inverter 120 to thereby prevent damage to the inverter 120. During such control, the photovoltaic cell module 110 is not able to provide the total power thereof.

Through such operation, the embodiment of the present invention provides the alternating current photovoltaic module 100 to efficiently manage the total power provided by the photovoltaic cell module 110, and excess electricity can be stored in the electricity storing component 130, so as to solve the problem of mismatch between the photovoltaic cell module 110 and the inverter 120. The stored electricity stored in the electricity storing component 130 can also be provided when the generated electricity generated by the photovoltaic cell module 110 is not sufficient. Also, the electricity storing component 130 may provide the stored electricity stored therein at night. As a result, the alternating current photovoltaic module 100 of the embodiment of the present disclosure can employ the photovoltaic cell module 110 to provide generated electricity or the electricity storing component 130 to provide the stored electricity stored therein as needed, and therefore, all the generated electricity generated by a solar energy panel is used efficiently.

In another embodiment of the present disclosure, referring to FIG. 1, the electricity transforming unit 122 is further electrically connected to a load 200. When the power of the generated electricity generated by the photovoltaic cell module 110 is less than the required power of the load 200, the control unit 128 operates to control the electricity storing component 130 to provide the stored electricity stored therein. In addition, when the power of the generated electricity generated by the photovoltaic cell module 110 is greater than the required power of the load 200 (for example, at an off-peak time of electricity utilization), the excess electricity can be managed efficiently and stored in the electricity storing component 130. For example, when there is insufficient or no sunshine, the power of the generated electricity generated by the photovoltaic cell module 110 will be less than the required power of the load 200, and the control unit 128 operates at this time to control the electricity storing component 130 to provide the stored electricity stored therein.

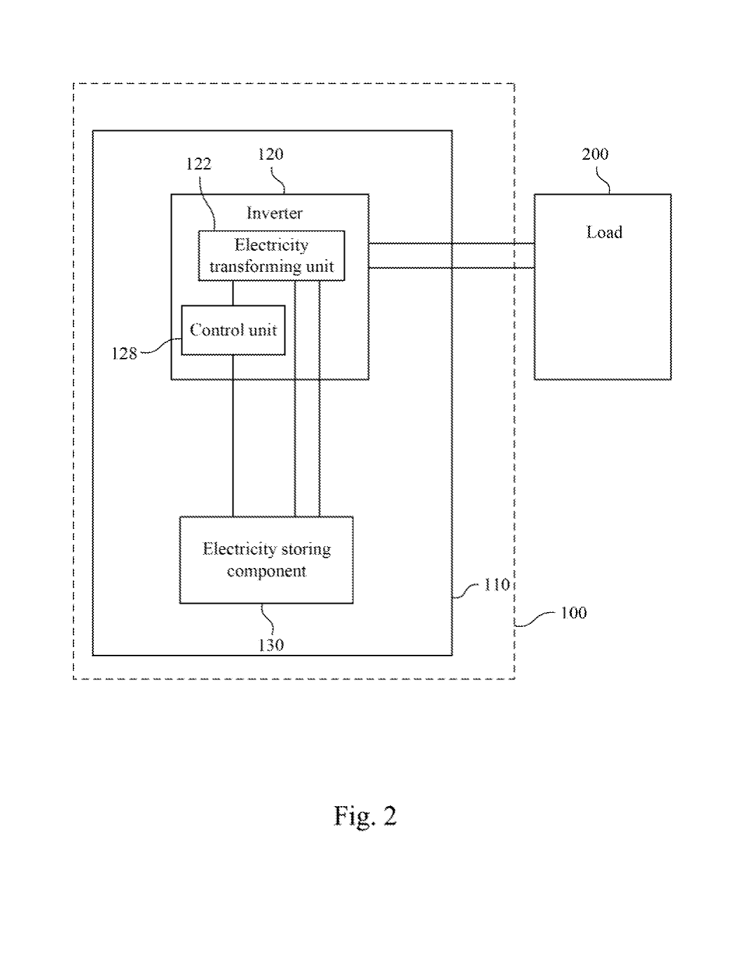

In an optional embodiment, the alternating current photovoltaic module 100 further comprises a junction box 150. The junction box 150 is electrically connected to the electricity transforming unit 122 of the inverter 120 and the photovoltaic cell module 110, and the photovoltaic cell module 110 is electrically connected to the electricity transforming unit 122 of the inverter 120 through the junction box 150. In another embodiment of the present disclosure, the junction box 150 can also be integrated in the inverter 120 as shown in FIG. 2. The difference between these two implementations is that users can more clearly understand the configuration of the circuit due to the separated socket of the junction box 150 when the junction box 150 is separated from the inverter 120, while manufacturing costs can be reduced when the junction box 150 is integrated in the inverter 120. Those skilled in the art can selectively adopt any of the above-mentioned two implementations to dispose the junction box 150 depending on actual requirements.

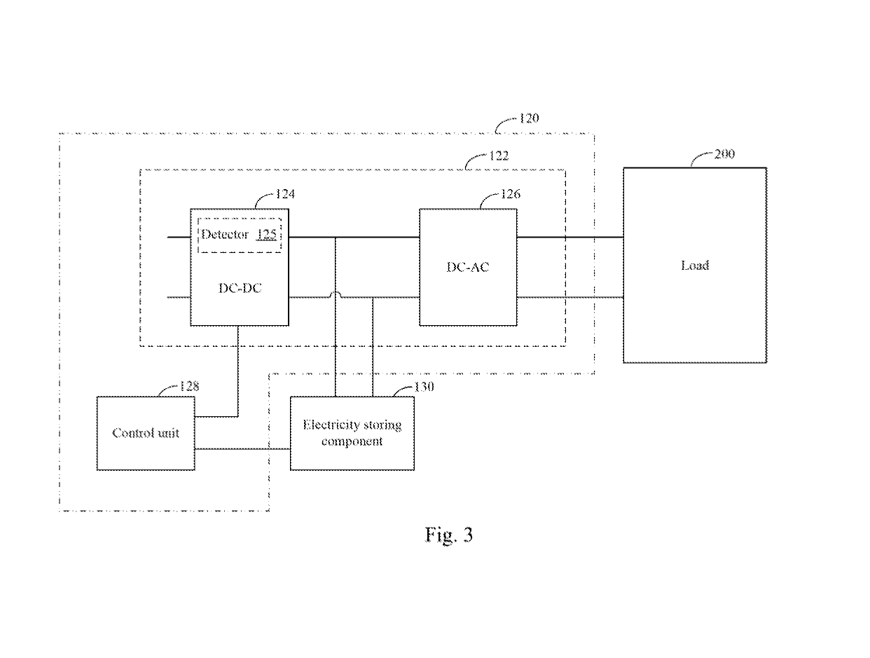

FIG. 3 schematically shows a circuit block diagram of an inverter 120 according to an embodiment of the present invention. As shown in the figure, the electricity transforming unit 122 of the inverter 120 comprises a direct current to direct current converter 124 and a direct current to alternating current converter 126. The direct current to direct current converter 124 is electrically connected to the photovoltaic cell module 110, the direct current to alternating current converter 126 is electrically connected to the direct current to direct current converter 124, and the electricity storing component 130 is electrically connected between the direct current to direct current converter 124 and the direct current to alternating current converter 126.

With respect to operation, the direct current to direct current converter 124 operates to transform the generated electricity generated by the photovoltaic cell module 110 into transformed electricity in direct current type, and the direct current to alternating current converter 126 operates to transform the transformed electricity transformed by the direct current to direct current converter 124 and/or the stored electricity stored in the electricity storing component 130 into an outputted electricity in alternating current type.

It is noted that the photovoltaic cell module 110 transforms the luminous energy into generated electricity in direct current type, and the electricity transforming unit 122 of the inverter 120 transforms the generated electricity generated by the photovoltaic cell module 110 into transformed electricity in alternating current type, so as to feed the transformed electricity in alternating current type transformed by the electricity transforming unit 122 into supply mains. In addition, because the alternating current photovoltaic module 100 of the embodiment of the present disclosure comprises the electricity storing component 130, the alternating current photovoltaic module 100 can be a grid-connected (on-grid) alternating current photovoltaic module and can also be a standalone (off-grid) alternating current photovoltaic module. When the alternating current photovoltaic module 100 is implemented as an independent alternating current photovoltaic module, the operation of the alternating current photovoltaic module 100 is similar to a mobile power pack. Electrical components can be directly connected to the standalone alternating current photovoltaic module and obtain electricity therefrom. However, the embodiment of the present disclosure is not intended to be limited in this regard, and these examples are provided for illustration purposes only to represent different possible implementations of the present disclosure.

When implementing the direct current to alternating current converter 126, those skilled in the art can selectively adopt a buck converter, a boost converter, a flyback converter, a forward converter, and so on to manufacture the direct current to alternating current converter 126 depending on actual requirements. In addition, when implementing the direct current to alternating current converter 126, those skilled in the art can selectively adopt a half bridge converter, a full bridge converter, a three-phase bridge converter, and so on to manufacture the direct current to alternating current converter 126 depending on actual requirements. However, the embodiment of the present disclosure is not intended to be limited in this regard, and these examples are provided for illustration purposes only to represent possible implementations of the present disclosure.

In addition, when the power of the generated electricity generated by the photovoltaic cell module 110 is greater than the rated power of the inverter 120, all or a portion of the transformed electricity transformed by the direct current to direct current converter 124 is provided to the electricity storing component 130, so as to store the all or a portion of the transformed electricity in the electricity storing component 130. Moreover, when the power of the generated electricity generated by the photovoltaic cell module 110 is less than the rated power of the inverter 120, the control unit 128 operates to control the electricity storing component 130 to provide the stored electricity stored in the electricity storing component 130, and the stored electricity stored in the electricity storing component 130 is transformed into the outputted electricity in alternating current type through the direct current to alternating current converter 126.

For example, when there is sufficient sunshine, the power of the generated electricity generated by the photovoltaic cell module 110 is greater than the rated power of the inverter 120, and as a result, the excess electricity can be managed efficiently and stored in the electricity storing component 130 at this time. On the other hand, when there is insufficient or no sunshine, the power of the generated electricity generated by the photovoltaic cell module 110 is less than the rated power of the inverter 120, and as a result, the control unit 128 operates at this time to control the electricity storing component 130 to provide the stored electricity stored therein.

In another embodiment of the present disclosure, the direct current to direct current converter 124 comprises a detector 125. The detector 125 is electrically connected to the photovoltaic cell module 110, and the detector 125 is configured to detect the generated electricity generated by the photovoltaic cell module 110 for obtaining the power of the generated electricity generated by the photovoltaic cell module 110. When implementing the detector 125, those skilled in the art can selectively adopt any electrical component which can detect voltage or current to realize the detector 125.

In another aspect of the present disclosure, the alternating current photovoltaic module 100 comprises a photovoltaic cell module 110, an inverter 120, and an electricity storing component 130, and the structure of the alternating current photovoltaic module 100 herein is the same as the previous aspect of the alternating current photovoltaic module 100 of the present disclosure, and accordingly a detailed description regarding the structure the alternating current photovoltaic module 100 herein is omitted for the sake of brevity.

With respect to operation, however, compared with the previous aspect of the alternating current photovoltaic module 100, the control unit 128 operates to control the inverter 120 to simultaneously transform the generated electricity and deliver the transformed electricity to the electricity storing component 130, so as to store the electricity in the electricity storing component 130. Therefore, the alternating current photovoltaic module 100 of the embodiment of the present disclosure can further employ the generated electricity generated by the photovoltaic cell module 110 efficiently.

The electricity transforming unit 122 of the inverter 120 herein also comprises a direct current to direct current converter 124 and a direct current to alternating current converter 126. The connection of the above-mentioned electrical components is the same as the connection of the previous aspect. In operation, compared with the previous aspect, the control unit 128 operates to control the direct current to direct current converter 124 to simultaneously provide a first portion of the transformed electricity transformed by the direct current to direct current converter 124 to the direct current to alternating current converter 126 and provide a second portion of the transformed electricity transformed by the direct current to direct current converter 124 to the electricity storing component 130. The direct current to alternating current converter 126 transforms the first portion of the transformed electricity into the outputted electricity in alternating current type, and at the same time, the electricity storing component 130 stores the second portion of the transformed electricity therein.

Furthermore, the alternating current photovoltaic module 100 also comprises a junction box 150. The junction box 150 is electrically connected to the electricity transforming unit 122 of the inverter 120 and the photovoltaic cell module 110, and the photovoltaic cell module 110 is electrically connected to the electricity transforming unit 122 of the inverter 120 through the junction box 150. The junction box 150 can be integrated in the inverter 120 as shown in FIG. 2. The difference between these two implementations is that users can more clearly understand the configuration of the circuit due to the separated socket of the junction box 150 when the junction box 150 is separated from the inverter 120, while manufacturing costs can be reduced when the junction box 150 is integrated in the inverter 120. Those skilled in the art can selectively adopt any of the above-mentioned two implementations to dispose the junction box 150 depending on actual requirements. However, the embodiment of the present disclosure is not intended to be limited in this regard, and these examples are provided for illustration purposes only to represent possible implementations of the present disclosure.

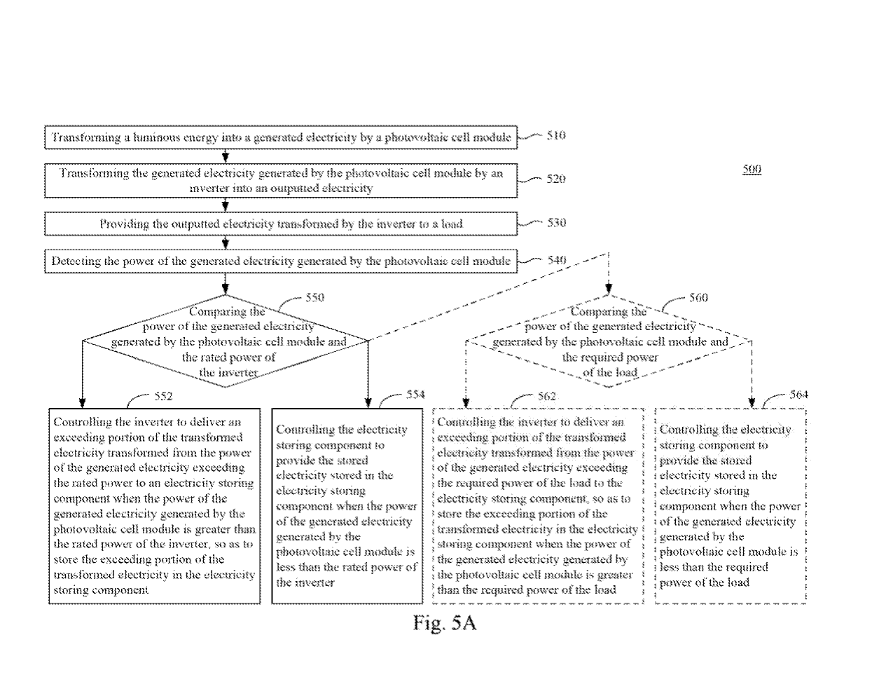

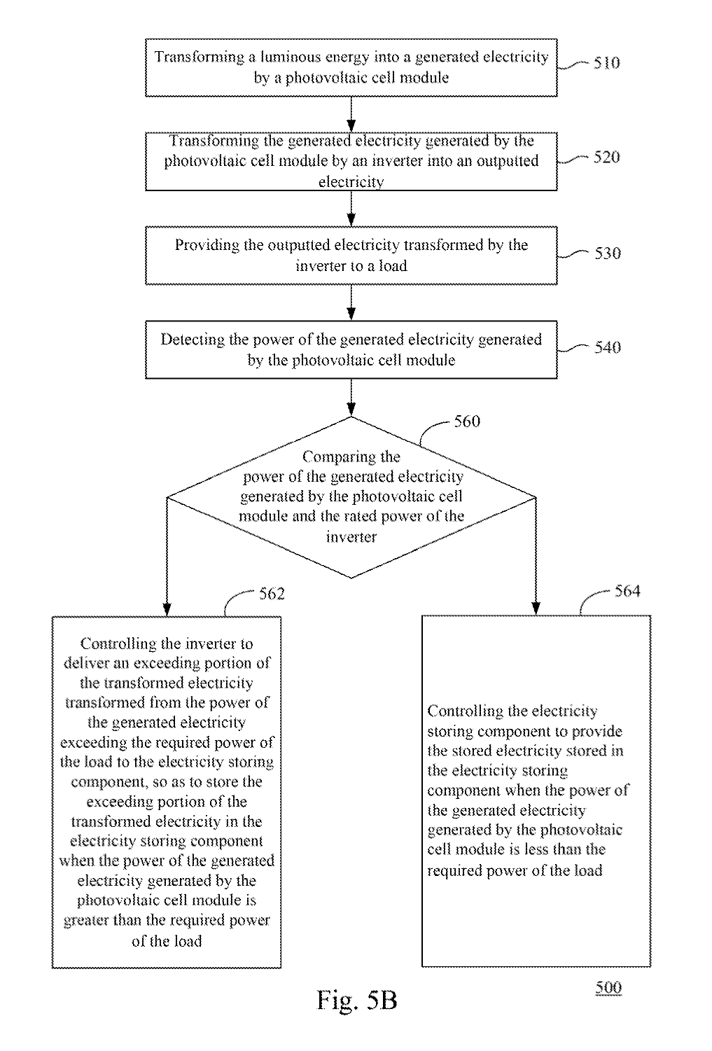

FIG. 5A schematically shows a flow diagram of a method 500 for managing electricity in an alternating current photovoltaic module according to an embodiment of the present invention. As shown in the figure, the method 500 for managing electricity comprises the steps of transforming a luminous energy into a generated electricity by a photovoltaic cell module (step 510); transforming the generated electricity generated by the photovoltaic cell module by an inverter into an outputted electricity (step 520); providing the outputted electricity transformed by the inverter to a load (step 530); detecting the power of the generated electricity generated by the photovoltaic cell module (step 540); comparing the power of the generated electricity generated by the photovoltaic cell module and the rated power of the inverter (step 550); controlling the inverter to deliver an exceeding portion of the transformed electricity transformed from the power of the generated electricity exceeding the rated power to an electricity storing component when the power of the generated electricity generated by the photovoltaic cell module is greater than the rated power of the inverter, so as to store the exceeding portion of the transformed electricity in the electricity storing component (step 552); and controlling the electricity storing component to provide the stored electricity stored in the electricity storing component when the power of the generated electricity generated by the photovoltaic cell module is less than the rated power of the inverter (step 554).

Reference is now made to both FIG. 1 and FIG. 5A. In step 510, when implementing the photovoltaic cell module 110, the photovoltaic cell module 110 can be implemented by conventional materials as described above with reference to FIG. 1. Such dissimilar materials differ in cost, electricity conversion efficiency, difficulty of manufacture, or related applications, and those skilled in the art can selectively adopt proper materials to manufacture the photovoltaic cell module 110 depending on actual requirements. Moreover, in step 520, when implementing the inverter 120, those skilled in the art can selectively adopt a square wave inverter, a step wave inverter, a sinusoidal wave inverter, and so on to manufacture the inverter 120 depending on actual requirements. However, the embodiment of the present disclosure is not intended to be limited in this regard, and these examples are provided for illustration purposes only to represent possible implementations of the present disclosure.

In step 530, the transformed electricity transformed by the inverter 120 of the alternating current photovoltaic module 100 is provided to the load 200. Referring to both step 540 and step 550, the power of the generated electricity generated by the photovoltaic cell module 100 can be detected by the detector 125. Subsequently, the power of the generated electricity generated by the photovoltaic cell module and the rated power of the inverter can be compared by the control unit 128.

Depending on the comparison result of step 550, step 552 or 554 is performed. That is, when the power of the generated electricity generated by the photovoltaic cell module 110 is greater than the rated power of the inverter 120, the inverter 120 is controlled to deliver the exceeding portion of the transformed electricity transformed by the photovoltaic cell module 110 exceeding the rated power to the electricity storing component 130, so as to store the exceeding portion of the transformed electricity in the electricity storing component 130 in step 552, and when the power of the generated electricity generated by the photovoltaic cell module 110 is less than the rated power of the inverter 120, the electricity storing component 130 is controlled to provide the stored electricity stored in the electricity storing component 130 in step 554.

For example, when there is sufficient sunshine, the power of the generated electricity generated by the photovoltaic cell module 110 is greater than the rated power of the inverter 120, and as a result, the excess electricity can be managing efficiently and stored in the electricity storing component 130. On the other hand, when there is insufficient or no sunshine, the power of the generated electricity generated by the photovoltaic cell module 110 is less than the rated power of the inverter 120, and as a result, the control unit 128 operates at this time to control the electricity storing component 130 to provide the stored electricity stored therein.

When implementing the electricity storing component 130, those skilled in the art can selectively adopt components which can store enough electricity such as a lead-acid battery, a nickel-cadmium battery, a nickel-metal hydride battery, a lithium ion battery, and so on to manufacture the electricity storing component 130. The above-mentioned components can provide stored electricity stored therein. However, the embodiment of the present disclosure is not intended to be limited in this regard, and these examples are provided for illustration purposes only to represent different possible implementations of the present disclosure.

As mentioned above, when the photovoltaic cell module 110 and the inverter 120 of the alternating current photovoltaic module 100 are used, the power of the photovoltaic cell module 110 and that of the inverter 120 are different, resulting in a problem of mismatch between the photovoltaic cell module 110 and the inverter 120. The total power provided by the photovoltaic cell module 110 is usually greater than the rated power of the inverter 120. In such a scenario, the inverter 120 will limit the total power provided by the photovoltaic cell module 110 in such a manner that the total power provided by the photovoltaic cell module 110 is not greater than the rated power of the inverter 120 to thereby prevent damage to the inverter 120. During such control, the photovoltaic cell module 110 is not able to provide the total power thereof.

Through such operation, the embodiment of the present invention provides the method 500 for managing electricity to efficiently manage the total power provided by the photovoltaic cell module 110, and excess electricity can be stored in the electricity storing component 130, so as to solve the problem of mismatch between the photovoltaic cell module 110 and the inverter 120. The stored electricity stored in the electricity storing component 130 can also be provided when the generated electricity generated by the photovoltaic cell module 110 is not sufficient. Also, the electricity storing component 130 may provide the stored electricity stored therein at night. As a result, the method 500 for managing electricity of the embodiment of the present disclosure can employ the photovoltaic cell module 110 to provide electricity or the electricity storing component 130 can be employed to provide the stored electricity stored therein as needed, and therefore, all the generated electricity generated by a solar energy panel is used efficiently.

In one embodiment, the method 500 for managing electricity of the embodiment of the present disclosure further comprises the steps of comparing the power of the generated electricity generated by the photovoltaic cell module and the required power of the load (step 560); controlling the inverter to deliver an exceeding portion of the transformed electricity transformed from the power of the generated electricity exceeding the required power of the load to the electricity storing component, so as to store the exceeding portion of the transformed electricity in the electricity storing component when the power of the generated electricity generated by the photovoltaic cell module is greater than the required power of the load (step 562); and controlling the electricity storing component to provide the stored electricity stored in the electricity storing component when the power of the generated electricity generated by the photovoltaic cell module is less than the required power of the load (step 564).

Reference is now made to both FIG. 1 and FIG. 5A. It is noted that the inverter 120 can be electrically connected to the load 200 as shown in FIG. 1. After performing step 550, the above-mentioned circuit configuration can be provided to selectively perform step 560 to further compare the power of the generated electricity generated by the photovoltaic cell module 110 and the required power of the load 200 by the control unit 128 when the power of the generated electricity generated by the photovoltaic cell module 110 is less than to the rated power of the inverter 120.

Depending on the comparison result of step 560, step 562 or 564 is performed. That is, when the power of the generated electricity generated by the photovoltaic cell module 110 is greater than the required power of the load 200, step 562 is performed to control the inverter 120 to deliver the exceeding portion of the transformed electricity transformed by the photovoltaic cell module 110 exceeding the required power of the load 200 to the electricity storing component 130, so as to store the exceeding portion of the transformed electricity in the electricity storing component 130, and when the power of the generated electricity generated by the photovoltaic cell module 110 is less than the required power of the load 200, step 564 is performed to control the electricity storing component 130 to provide the stored electricity stored in the electricity storing component 130.

In one embodiment, the inverter 120 comprises a direct current to direct current converter 124 and a direct current to alternating current converter 126. In step 520, the step of transforming the generated electricity generated by the photovoltaic cell module by the inverter 120 further comprises transforming the generated electricity generated by the photovoltaic cell module 110 into transformed electricity by the direct current to direct current converter 124, and transforming all or a portion of the transformed electricity transformed by the direct current to direct current converter 124 into the outputted electricity in alternating current type by the direct current to alternating current converter 126. The step of providing the transformed electricity transformed by the inverter 120 to the load 200 involves providing the outputted electricity in alternating current type transformed by the direct current to alternating current converter 126 to the load 200. The step of controlling the inverter 120 to deliver the exceeding portion of the transformed electricity transformed by the photovoltaic cell module 110 exceeding the rated power to the electricity storing component 130, so as to store the exceeding portion of transformed electricity in the electricity storing component 130 involves providing all or a portion of the transformed electricity transformed by the direct current to direct current converter 124 to the electricity storing component 130, so as to store all or a portion of the transformed electricity in the electricity storing component. The step of controlling the electricity storing component 130 to provide the stored electricity stored in the electricity storing component 130 involves controlling the electricity storing component 130 to provide the stored electricity stored in the electricity storing component 130 to the direct current to alternating current converter 126 for transforming the stored electricity stored in the electricity storing component into the outputted electricity in alternating current type.

It is noted that the photovoltaic cell module 110 transforms the luminous energy into generated electricity in direct current type, and the inverter 120 transforms the generated electricity generated by the photovoltaic cell module 110 into the outputted electricity in alternating current type, so as to feed the outputted electricity transformed by the electricity transforming unit 122 into supply mains. In addition, because of the method 500 for managing electricity of the embodiment of the present disclosure can be performed with the electricity storing component 130, the method 500 for managing electricity can not only feed the outputted electricity transformed by the electricity transforming unit 122 into supply mains, but the operation thereof is similar to a mobile power pack so that electrical components can directly obtain electricity from the electricity storing component 130.

When implementing the direct current to alternating current converter 126, those skilled in the art can selectively adopt a buck converter, a boost converter, a flyback converter, a forward converter, and so on to manufacture the direct current to alternating current converter 126 depending on actual requirements. In addition, when implementing the direct current to alternating current converter 126, those skilled in the art can selectively adopt a half bridge converter, a full bridge converter, a three-phase bridge converter, and so on to manufacture the direct current to alternating current converter 126 depending on actual requirements. However, the embodiment of the present disclosure is not intended to be limited in this regard, and these examples are provided for illustration purposes only to represent possible implementations of the present disclosure.

In another embodiment of the present disclosure, the power of the generated electricity generated by the photovoltaic cell module 110 and the required power of the load 200 is compared. When the power of the generated electricity generated by the photovoltaic cell module 110 is less than the rated power of the inverter 120, the electricity storing component 130 is controlled to provide the stored electricity stored in the electricity storing component 130, and the stored electricity stored in the electricity storing component 130 is transformed into the outputted electricity in alternating current type through the direct current to alternating current converter 126.

In still another embodiment, the method 500 for managing electricity of the embodiment of the present disclosure further comprises the steps of controlling the inverter 120 to simultaneously transform the generated electricity and deliver the transformed electricity to the electricity storing component 130, and this step can be performed through control by the control unit 128. Hence, the method 500 for managing electricity of the embodiment of the present disclosure can achieve efficient use of the electricity generated by the photovoltaic cell module 110.

FIG. 5B schematically shows a flow diagram of a method 500 for managing electricity in an alternating current photovoltaic module according to another embodiment of the present invention. As shown in the figure, the method 500 for managing electricity comprises the above-mentioned steps 510 to 540, 560, 562, and 564, and a description of each of the steps is provided above with reference to FIG. 5A. Compared to the method described with reference to FIG. 5A, the method of FIG. 5B includes step 560 which is performed to compare the power of the generated electricity generated by the photovoltaic cell module 110 and the required power of the load 200 after step 540 is finished, and step 562 or step 564 is performed depending on the comparison result. FIG. 5B is used to describe another aspect of the method 500 for managing electricity of the embodiment of the present disclosure. The implementation of each of the steps is described with reference to FIG. 5A, and accordingly, a detailed description with respect to the implementations of the steps in FIG. 5B is omitted herein for the sake of brevity.

Those having skill in the art will appreciate that the method for managing electricity can be performed with software, hardware, and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of the method for managing electricity is named in accordance with the function performed in said step, and such naming is merely used to describe the technology in the embodiment of the present invention in detail, but the present invention is not limited in this regard. Therefore, combining the steps of said method into one step, dividing the steps into several steps, or rearranging the order of the steps is within the scope of the embodiment in the present invention.

In view of the foregoing embodiments of the present invention, many advantages of the present invention are now apparent. The embodiment of the present invention provides an alternating current photovoltaic module 100 and a method 500 for managing electricity therein to efficiently manage the total power provided by the photovoltaic cell module 110, and store excess electricity in the electricity storing component 130, so as to solve the problem of mismatch between the photovoltaic cell module 110 and the inverter 120. The stored electricity stored in the electricity storing component 130 can also be provided when the generated electricity generated by the photovoltaic cell module 110 is not sufficient. Also, the electricity storing component 130 will provide the stored electricity stored therein at night. As a result, the alternating current photovoltaic module 100 of the embodiment of the present disclosure can employ the photovoltaic cell module 110 to provide the generated electricity or the electricity storing component 130 can be employed to provide the stored electricity stored therein as needed, and therefore, all the generated electricity generated by a solar energy panel is used efficiently.

In addition, because the embodiment of the present invention provides the electricity storing component 130 of the alternating current photovoltaic module 100, the alternating current photovoltaic module 100 can be a standalone alternating current photovoltaic module, and the method 500 for managing electricity of the embodiment of the present disclosure can be performed with the electricity storing component 130. Therefore, electrical components can be directly connected to the electricity storing component 130 to obtain electricity therefrom. Moreover, the alternating current photovoltaic module 100 and the method 500 for managing electricity of one aspect of the present disclosure is operated to control inverter 120 to simultaneously transform the generated electricity and deliver the transformed electricity to the electricity storing component 130, so as to store the transformed electricity in the electricity storing component 130. Therefore, the generated electricity generated by the photovoltaic cell module 110 can be employed efficiently.

As a result, the embodiment of the present invention provides the alternating current photovoltaic module 100 and the method 500 for managing electricity to efficiently manage the total power provided by the photovoltaic cell module 110, and excess electricity can be stored in the electricity storing component 130. The stored electricity stored in the electricity storing component 130 can also be provided when the generated electricity generated by the photovoltaic cell module 110 is not sufficient. Also, the electricity storing component 130 may provide the stored electricity stored therein at night. As a result, the alternating current photovoltaic module 100 and the method 500 for managing electricity of the embodiment of the present disclosure can employ the photovoltaic cell module 110 to provide generated electricity or the electricity storing component 130 can be employed to provide the stored electricity stored therein as needed, and therefore, all the generated electricity generated by a solar energy panel is used efficiently.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. An alternating current photovoltaic module operated to provide electricity to a load, the alternating current photovoltaic module comprising:
a photovoltaic cell module operated to transform a luminous energy into a generated electricity;
an inverter comprising:
an electricity transforming unit electrically connected to the photovoltaic cell module and the load to transform the generated electricity generated by the photovoltaic cell module; and
a control unit electrically connected to the electricity transforming unit; and
an electricity storing component electrically connected to the electricity transforming unit and the control unit and operated to store a transformed electricity transformed by the electricity transforming unit;
wherein the control unit is configured to control the inverter to deliver the transformed electricity transformed by the electricity transforming unit to the electricity storing component, so as to store the transformed electricity in the electricity storing component and control the electricity storing component for providing a stored electricity stored in the electricity storing component.

2. The alternating current photovoltaic module according to claim 1, wherein when a power of the generated electricity generated by the photovoltaic cell module is greater than a rated power of the inverter, the control unit is operable to control the inverter to deliver a exceeding portion of the transformed electricity exceeding the rated power to the electricity storing component, so as to store the exceeding portion of the transformed electricity in the electricity storing component.

3. The alternating current photovoltaic module according to claim 2, wherein when the power of the generated electricity generated by the photovoltaic cell module is less than the rated power of the inverter, the control unit is operable to control the electricity storing component to provide a stored electricity stored in the electricity storing component.

4. The alternating current photovoltaic module according to claim 3, wherein the electricity transforming unit comprises:
a direct current to direct current converter electrically connected to the photovoltaic cell module and configured to transform the generated electricity generated by the photovoltaic cell module into the transformed electricity in direct current type; and
a direct current to alternating current converter electrically connected to the direct current to direct current converter and configured to transform the transformed electricity transformed by the direct current to direct current converter and/or the stored electricity stored in the electricity storing component into an output electricity in alternating current type.

5. The alternating current photovoltaic module according to claim 4, wherein the electricity storing component is electrically connected between the direct current to direct current converter and the direct current to alternating current converter, when the control unit is configured to control the inverter to deliver the transformed electricity transformed by the direct current to direct current converter to the electricity storing component, so as to store the transformed electricity in the electricity storing component, all or a portion of the transformed electricity transformed by the direct current to direct current converter is provided to the electricity storing component, so as to store all or a portion of the transformed electricity in the electricity storing component, and when the control unit is operable to control the electricity storing component to provide the stored electricity stored in the electricity storing component, the stored electricity stored in the electricity storing component is transformed into an output electricity in alternating current type through the direct current to alternating current converter.

6. The alternating current photovoltaic module according to claim 1, wherein when a power of the generated electricity generated by the photovoltaic cell module is greater than a required power of the load, the control unit is operable to control the inverter to deliver an exceeding portion of the transformed electricity exceeding the required power of the load to the electricity storing component, so as to store the exceeding portion of the transformed electricity in the electricity storing component.

7. The alternating current photovoltaic module according to claim 6, wherein when the power of the generated electricity generated by the photovoltaic cell module is less than the required power of the load, the control unit is operable to control the electricity storing component to provide a stored electricity stored in the electricity storing component.

8. The alternating current photovoltaic module according to claim 7, wherein the electricity transforming unit comprises:
a direct current to direct current converter electrically connected to the photovoltaic cell module and configured to transform the generated electricity generated by the photovoltaic cell module into the transformed electricity in direct current type; and
a direct current to alternating current converter electrically connected to the direct current to direct current converter and configured to transform the transformed electricity transformed by the direct current to direct current converter and/or the stored electricity stored in the electricity storing component into an output electricity in alternating current type.

9. The alternating current photovoltaic module according to claim 8, wherein the electricity storing component is electrically connected between the direct current to direct current converter and the direct current to alternating current converter, when the control unit is operable to control the inverter to deliver the transformed electricity transformed by the electricity transforming unit; to the electricity storing component, so as to store the transformed electricity in the electricity storing component, all or a portion of the transformed electricity transformed by the direct current to direct current converter is provided to the electricity storing component, so as to store all or a portion of the transformed electricity in the electricity storing component, and when the control unit is operable to control the electricity storing component to provide the stored electricity stored in the electricity storing component, the stored electricity stored in the electricity storing component is transformed into alternating current through the direct current to alternating current converter.

10. The alternating current photovoltaic module according to claim 1, wherein the electricity transforming unit comprises:
a direct current to direct current converter electrically connected to the photovoltaic cell module and configured to transform the generated electricity generated by the photovoltaic cell module into the transformed electricity in direct current type; and
a direct current to alternating current converter electrically connected to the direct current to direct current converter and configured to transform the transformed electricity transformed by the direct current to direct current converter and/or the stored electricity stored in the electricity storing component into an output electricity in alternating current type.

11. The alternating current photovoltaic module according to claim 10, wherein the electricity storing component is electrically connected between the direct current to direct current converter and the direct current to alternating current converter, when the control unit is configured to control the inverter to deliver the transformed electricity transformed by the direct current to direct current converter to the electricity storing component, so as to store the transformed electricity in the electricity storing component, all or a portion of the direct current transformed by the direct current to direct current converter is provided to the electricity storing component, so as to store all or a portion of the direct current in the electricity storing component, and when the control unit is operable to control the electricity storing component to provide the stored electricity stored in the electricity storing component, the stored electricity stored in the electricity storing component is transformed into alternating current through the direct current to alternating current converter.

12. The alternating current photovoltaic module according to claim 10, wherein the electricity storing component is electrically connected between the direct current to direct current converter and the direct current to alternating current converter.

13. The alternating current photovoltaic module according to claim 12, wherein the direct current to direct current converter comprises a detector which is electrically connected to the photovoltaic cell module, and the detector is configured to detect the generated electricity generated by the photovoltaic cell module for obtaining the power of the generated electricity generated by the photovoltaic cell module.

14. The alternating current photovoltaic module according to claim 1, further comprising:
a junction box electrically connected to the electricity transforming unit and the photovoltaic cell module, wherein the photovoltaic cell module is electrically connected to the electricity transforming unit through the junction box.

15. A method for managing electricity in an alternating current photovoltaic module, the method comprising:
transforming a luminous energy into a generated electricity by a photovoltaic cell module;
transforming the generated electricity generated by the photovoltaic cell module by an inverter into an outputted electricity;
providing the outputted electricity transformed by the inverter to a load;
controlling the inverter to deliver an exceeding portion of a transformed electricity transformed from the generated electricity exceeding the rated power to the electricity storing component when the power of the generated electricity generated by the photovoltaic cell module is greater than the rated power of the inverter, so as to store the exceeding portion of the transformed electricity in the electricity storing component; and
controlling the electricity storing component to provide a stored electricity stored in the electricity storing component when the power of the generated electricity generated by the photovoltaic cell module is less than the rated power of the inverter.

16. The method according to claim 15, wherein controlling the electricity storing component to provide the stored electricity stored in the electricity storing component when the power of the generated electricity generated by the photovoltaic cell module is less than the rated power of the inverter comprises controlling the electricity storing component to provide the stored electricity stored in the electricity storing component when the power of the generated electricity generated by the photovoltaic cell module is less than the rated power of the inverter and the power of the generated electricity generated by the photovoltaic cell module is less than a required power of the load.

17. The method according to claim 16, wherein the inverter comprises a direct current to direct current converter and a direct current to alternating current converter, and transforming the generated electricity generated by the photovoltaic cell module by the inverter into the outputted electricity comprises:
transforming the generated electricity generated by the photovoltaic cell module into the transformed electricity in direct current type by the direct current to direct current converter; and
transforming all or a portion of the transformed electricity transformed by the direct current to direct current converter into the outputted electricity in alternating current type by the direct current to alternating current converter;
wherein:
providing the outputted electricity transformed by the inverter to the load comprises providing the outputted electricity transformed by the direct current to alternating current converter to the load;
controlling the inverter to deliver a exceeding portion of the transformed electricity exceeding the rated power to the electricity storing component, so as to store the exceeding portion of the transformed electricity in storing component comprises providing all or a portion of the transformed electricity transformed by the direct current to direct current converter to the electricity storing component, so as to store all or a portion of the transformed electricity in the electricity storing component; and
controlling the electricity storing component to provide the stored electricity stored in the electricity storing component comprises controlling the electricity storing component to provide the stored electricity stored in the electricity storing component to the direct current to alternating current converter for transforming the stored electricity stored in the electricity storing component into the output electricity.

18. A method for managing electricity in an alternating current photovoltaic module, the method comprising:
transforming a luminous energy into a generated electricity by a photovoltaic cell module;
transforming the generated electricity generated by the photovoltaic cell module by an inverter into an outputted electricity;
providing the outputted electricity transformed by the inverter to a load;
controlling the inverter to deliver a exceeding portion of a transformed electricity transformed from the generated electricity exceeding a required power of the load to the electricity storing component, so as to store the exceeding portion of the transformed electricity in the electricity storing component when a power of the generated electricity generated by the photovoltaic cell module is greater than the required power of the load; and
controlling the electricity storing component to provide the stored electricity stored in the electricity storing component when the power of the generated electricity generated by the photovoltaic cell module is less than the required power of the load.

19. The method according to claim 18, wherein the controlling the electricity storing component to provide the stored electricity stored in the electricity storing component when the power of the generated electricity generated by the photovoltaic cell module is less than the required power of the load comprises controlling the electricity storing component to provide the stored electricity stored in the stored electricity storing component when the power of the generated electricity generated by the photovoltaic cell module is less than the required power of the load and the power of the generated electricity generated by the photovoltaic cell module is less than the rated power of the inverter.

20. The method according to claim 19, wherein the inverter comprises a direct current to direct current converter and a direct current to alternating current converter, and transforming the generated electricity generated by the photovoltaic cell module by the inverter into the outputted electricity comprises:
transforming the generated electricity generated by the photovoltaic cell module into the transformed electricity in direct current type by the direct current to direct current converter; and
transforming all or a portion of the transformed electricity transformed by the direct current to direct current converter into the outputted electricity in alternating current type by the direct current to alternating current converter;
wherein:
providing the outputted electricity transformed by the inverter to the load comprises providing the outputted electricity transformed by the direct current to alternating current converter to the load;
controlling the inverter to deliver a exceeding portion of the transformed electricity transformed from the power of the generated electricity exceeding the rated power to the electricity storing component, so as to store the exceeding portion of the transformed electricity in storing component comprises providing all or a portion of the transformed electricity transformed by the direct current to direct current converter to the electricity storing component, so as to store all or a portion of the transformed electricity in the electricity storing component; and
controlling the electricity storing component to provide the stored electricity stored in the electricity storing component comprises controlling the electricity storing component to provide the stored electricity stored in the electricity storing component to the direct current to alternating current converter for transforming the stored electricity stored in the electricity storing component into the output electricity.
